(19) United States
(12) Patent Application Publication
(10) Pub. No.: US 2016/0146600 A1
(43) Pub. Date: May 26, 2016

(54) NOVEL TECHNIQUE OF DISPLACEMENT AND ROTATION MEASUREMENT

(71) Applicant: Shervin Taghavi Larigani, Woodland Hills, CA (US)

(72) Inventor: Shervin Taghavi Larigani, Woodland Hills, CA (US)

(21) Appl. No.: 14/552,385

(22) Filed: Nov. 24, 2014

(51) Int. Cl. G01B 21/16

(52) U.S. Cl. CPC G01B 21/16

(57) ABSTRACT

A simple and reliable novel method providing the ability to measure the spatial relative displacement and rotation of objects as well as the measurement of the different degrees of freedom of each object (i.e. rotations and translations) relative to an inertial frame. This novel technique relies on the measurement of the center of an energy pattern emanating from a source to a detector. Our technique can be used in diverse applications like remote sensing, as it applies to earth/planetary and geo sciences, oil/gas exploration, and mining, civil, structural, medical engineering, and homeland security & defense, among others.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

This application is related to the following patent application, which application is incorporated by reference herein:

Provisional Application Serial No. 61907826,573, filed on Nov. 22, 2013, by Shervin Taghavi Larigani, entitled “Novel relative rotation and displacement measurement technique between different objects”, attorneys' docket number508328757; filed by Shervin Taghavi Larigani through Legalzoom order number: Order #33342989

### BACKGROUND OF THE INVENTION

The present invention relates to the measurement of the six degree of freedom of an object in space such as three translations and three rotations.

### DESCRIPTION OF THE RELATED ART

Currently, not a single technique of measurement encompasses the measurement of the six degree of freedom of an object. Often for the same object different type of measurement devices are used to only a recover portion of the six degree of freedom of the object.

For the most part prior techniques rely on the measurement of phase such as all kind of range measurement or on mechanical moving component such as seismometer that is sensitive to up-down motions of the earth can be understood by visualizing a weight hanging on a spring.

1) Range Measurement

Interferometer range measurement is used as a means of monitoring minus range change while system similar to Pulse-Doppler radar determines the range to a target using pulse-timing techniques, and uses the Doppler shift of the returned signal to determine the target object's velocity and distance. Before looking at more detail to those techniques it is noteworthy to observe that if the target moves along a circle with constant radius or range away from the detector, then ranging system monitoring the change of the range would not detect the motion of the target. Indeed as the physical distance or range between two objects changes this induced a change of the optical length between the two of them, hence the change of the phase of an EM wave propagating from one end to the other one. By monitoring the changes in the phase of the wave, one deduces the change in distance. However this technique does not allow measuring the change in distance in the plane perpendicular to the axis of propagation of the wave. Another limitation of this technique pertains to its dynamic range defined as the maximum range of measurement possible over the smallest one Indeed the phase change induced by the change in the optical length is modulo 2 pi and is expressed as:

$$Δ φ = \frac{2 π}{λ} \cdot Δ d$$

Δd being the change in distance, λ the wavelength of the EM field and Δφ being the change in phase induced by the change in distance. This technique allows changes in distance equal to a fraction of wavelength, and is typically used to monitor very tiny change in distance.

For more coarse measurement, a pulse signal is used relying on a pulse-timing techniques where the measurement resolution is limited by the duration of the pulse and equals to C·τ where C is the speed of light and τ the duration of the pulse. For example for a pulse duration of 1 us the distance measurement resolution will be of 300 m. In order to improve the resolution, the emitted signal is modulated and thus the resolution of the measurement becomes

$$\frac{c}{2 B}$$

where B is the bandwidth of the modulation. This is how pulse Doppler radar technique operates.

Another means of measuring the spatial displacement of an object consists of using a trilateration system. It is nothing else than a range measurement involving three different measurements relative to three known references, which locations in space are known. Trilateration is the system that a GPS receiver uses to calculate its location. It relies on a set of three range measurements (as discussed earlier) relative to three different references, which locations are known.

The surface of equidistant relative to a point reference is the surface of a sphere. Each separate range measurement yields to a specific surface. The intersections of these surface leads to the location of the object. By monitoring the change of the range distance from the target relative to the references one could deduce the spatial location of the target relative to the reference.

Another technique is the triangulation consisting of determining the location of a point by measuring angles to it from known points at either end of a fixed baseline, rather than measuring distances to the point directly (trilateration). It does involve the measurement of angles.

Other technique such the conventional seismometer involves monitoring the mechanical motion of an object. Indeed a conventional simple seismometer could be visualized by a weight hanging on a spring. The spring and weight are suspended from a frame that moves along with the earth's surface. The relative motion between the earth and the weight provides a measure of the vertical ground motion as the earth moves. If a recording system is installed, this relative motion between the weight and earth can be recorded to produce a history of ground motion, called a seismogram. Likewise different technique of rotation and rotation technique exist where one of the most notable is a gyroscope based on the principles of angular momentum, typically comprise mechanical moving objects.

But none of them is measuring at the same time rotations and distances . . . .

Our technique differentiates itself from all of them in many aspects:
It is not a phase measurement.
It is simple.
It does not require moving objects.
It has high dynamic range as defined as the ratio between the largest and smallest possible values of the measurement. We believe that by combining the implementation of a precise measurement of our technique with its coarse implementation in the same apparatus measurement, we could reach a dynamic range of 10 orders of magnitude, which is the dynamic range of Earth.
Our technique could measure both rotation and displacement.
As opposed to many other technique measure the displacement of the beam in the time domain, thus leads directly to the measurement of the speed and acceleration without having to use any Fourier or inverse Fourier transform. We need only two measurements to calculate speed and three measurements to calculate acceleration. Indeed lets' assume Δ̅L̅(̅n̅·̅T̅)̅ being the relative displacement of the objects at time nT. Then only two measurements are needed to calculate the speed

$$\vec{v ( n . T )} = \frac{\vec{Δ L ( n . T )} - \vec{Δ L ( ( n - 1 ) . T )}}{T}$$

Likewise we could calculate the acceleration only with three measurements

$$and \vec{a ( n . T )} = \frac{\vec{Δ L ( ( n + 1 ) . T )} - \vec{2. Δ L ( n . T )} + \vec{Δ L ( ( n - 1 ) . T )}}{2. {T}^{2}}$$

Hence the same device could be a multipurpose device.
Our technique can be used in diverse applications like remote sensing, as it applies to earth/planetary and geo sciences, oil/gas exploration, and mining, civil, structural, medical engineering, and homeland security & defense, among others. The same measurement could be used to calculate the displacement, speed, acceleration and rotations. This device could be used for an abundance of different application. For example such as: accelerometer, gravity meter, strain gauge, torque measurement,

### SUMMARY OF THE INVENTION

We are proposing a technique for measuring the relative displacement and rotation between several objects (either moving, like satellites, airplanes, balloons, or cars, or static, like stations on the ground, or composed of both moving and static objects) This is done by monitoring the relative displacement of the geometrical center of the energy pattern emitted from a source (located on the emitting object) measured at the receiving object through centroid algorithms, which detect the center of the pattern.

Any deviation of the geometrical center of the energy pattern relative to the detector can be detected. Such deviation could be used to interpolate or derive a measurement of magnitude of the relative external force experienced by the objects, which is not a phase measurement.

An object is said to be an emitter so long a consistent energy pattern either passively or actively is emitted from it toward a detector. Each object could be either an emitter or a receiver relative to any other objects.

By increasing the number of independent measurements, we can measure the relative rotations of the objects in addition to their relative displacements. Instead of just two objects, one could extend this idea to a network of different objects.

In some specific cases where there are no practical limitations, one could envisage to measure all three-dimensional spatial components of the displacement by adding a measurement with a different angle of incidence. This angle would be between the direction of propagation of the incoming energy beam and the perpendicular to the surface containing the detector cells.

### BRIEF DESCRIPTION OF THE DRAWINGS

FIG. 1: Depicts a basic case where an energy beam pattern is emanating from a source to a detector. The detector monitors the position of the energy pattern on its plate but monitoring the center of the pattern using a centroid algorithm.

FIG. 2: Depicts a network composed by a multiple of objects. Each object could act as source for one, two or any other objects simultaneously. The same object could act as a detector for one, two or as many other objects. In the case (a) the unit component are similar. In case (b) depicts a hybrid non-inhomogeneous network where each objects of the network could be different that the other.

FIG. 3: Illustrates how the same technique could be used to measure range in addition of measuring the relative transversal displacement of the objects

FIG. 4: Depicts the case only one detector cell is used. As long as the energy pattern is inside the detector area; there is no mean of monitoring its displacement. The only information it exhibits regards the relative amount of energy that has moved outside the detector area. It does not provide any information about its direction of displacement.

FIG. 5: Depicts two detector cells located in the transversal direction. As long a minimum amount of energy is collected by each detectors, this set up provides information related to the displacement of the energy pattern in the transversal direction but falls short to provide information about the vertical direction displacement.

FIG. 6: Depicts a quad cell scheme. As long a minimum amount of energy is collected by each detector, this set up provides information related to the displacement of the energy pattern both in the transverse and vertical directions

FIG. 7: Depicts the case where we are interested in increasing the maximum resolution of measurements, where the image of the target on the screen of the detector is monitored. Each square is a unit detector cell.

FIG. 8: Depicts the same method as of FIG. 7 where the target has moved and rotated relative to the target.

FIG. 9: Depicts two random objects of the network where an energy pattern is emitted from each one of them toward the other one relative to an external referential frame.

FIG. 10: Depicts how the rotation of the source relative to a referential frame induces the displacement of the energy pattern at the detection.

FIG. 11: Depicts how the relative translation between a source and a detector induces a displacement of the energy pattern at the detector.

FIG. 12: Depicts the case where we are interested in measuring higher relative displacement/rotation. The detector is monitoring the image of a selected feature on the target.

FIG. 13: Depicts the case where the monitored feature on the target has moved and rotated relative to the detector. The motion of the target induces a motion of the image of the special feature on the screen of the detector. By monitoring the motion of the latter relative to the frame of the detector one could deduce the relative motions of the targeted object (source) relative to the detector.

FIG. 14: Depicts the Field Of View of the detector. As long as the source object or target displaces and rotates in the field of view of the detector. The latter can deduce the relative motions of the target.

FIG. 15: Illustrates how the collimation of the energy beam from the source affect the beam size at the detection.

FIG. 16: illustrates the logical flow for measuring a relative displacement and rotation in accordance with one or more embodiments of the invention

FIG. 17: is an exemplary hardware and software environment used to perform computations in accordance with one or more embodiments of the invention.

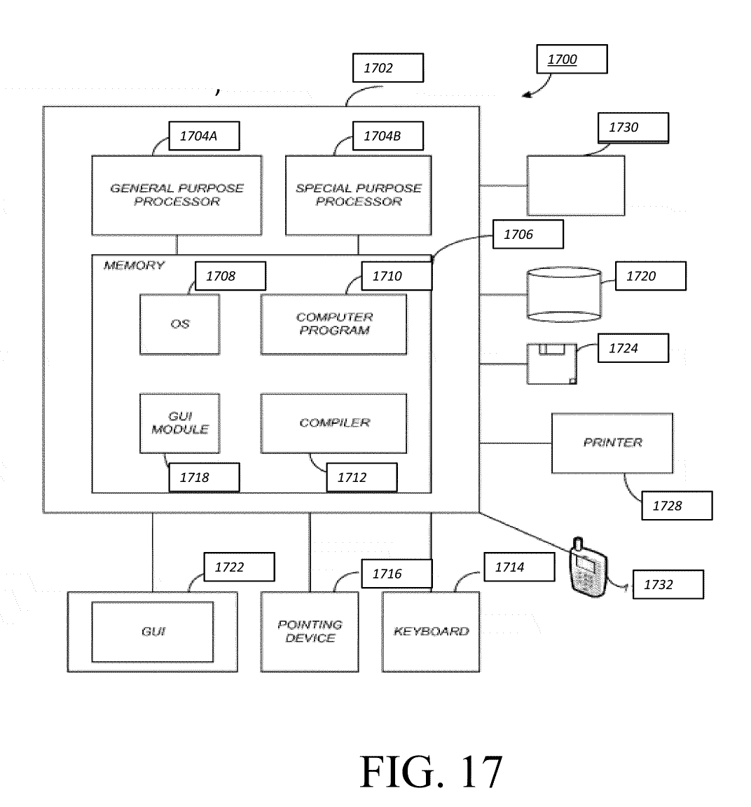

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

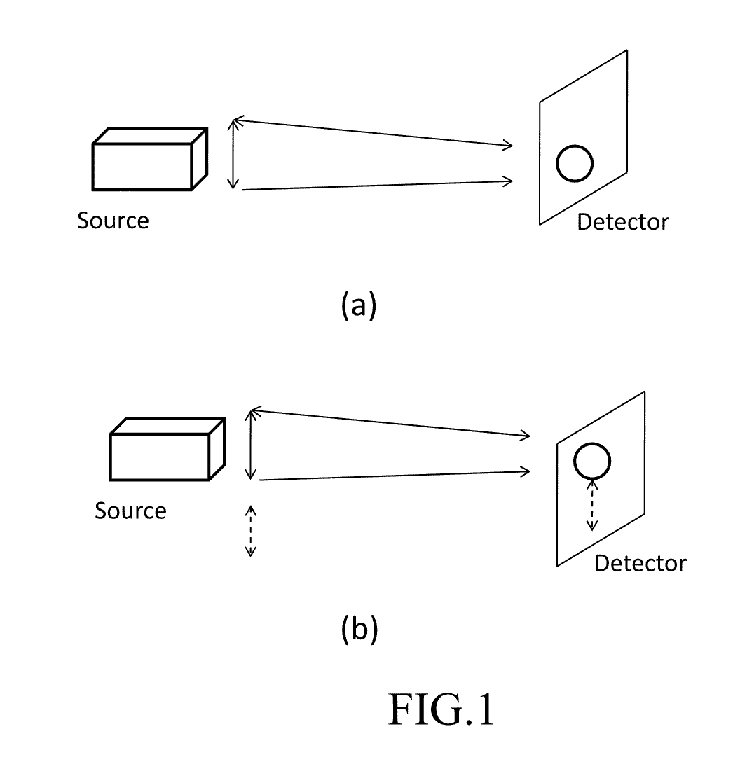

We are proposing a technique for measuring the displacement and rotation between several objects (either moving, like satellites, airplanes, balloons, or cars, or static, like stations on the ground, or composed of both moving and static objects) This is done by monitoring the relative displacement of the geometrical center of the energy pattern created by an emitting energy source (located on the emitting object) measured at the receiving object through centroid algorithms (that detect the center of a pattern), which could use a zero-sum equation, for example. FIG. 1 depicts a simple implementation of such technique where the detector monitors the displacement of the energy pattern on its plate. Once the source is moving relative to the detector so does the center of the energy pattern emitted from the source to the detector. By monitoring the displacement of the energy pattern at the detector one could measure the displacement of the source object relative to the detector object.

Any deviation of the geometrical center of the energy pattern relative to the detector can be detected. Such deviation could be used to interpolate or derive a measurement of magnitude of the relative external force experienced by the objects, which is not a phase measurement.

An object is said to be an emitter so long a consistent energy pattern either passively or actively is emitted from it toward a detector. As an example, an active source of energy could consist of a light beam emitted from the source such as LED or a laser, while the passive source of energy would be the image of a specific feature on the source that is being monitor at the detector, thus using the ambient light. Those are just few examples among many others.

The energy pattern could also be of different nature:
A energy wave pattern or a particle pattern.
As an example among others an energy wave pattern could include any Electromagnetic waves (e.g.: light, infra red, or any other frequency spectrum etc. . . . ) heat, any mechanical wave (acoustic waves such as ultra sonic and others etc. . . . ) light, heat, E&M wave, electron, positron neutron particle etc. . . . ) from the source to the detector.
A particle energy pattern could be composed of any unit particle.
As an example among others an energy particle pattern could be composed of electrons, neutrons, positrons, ions atoms or any other particles.

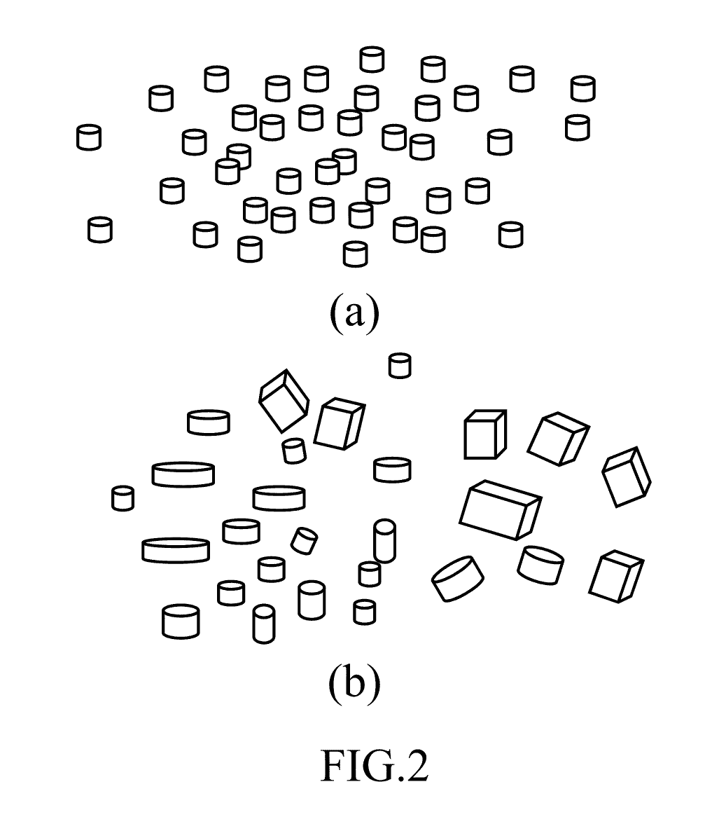

Each object could be either an emitter or a receiver relative to any other objects. By increasing the number of independent measurements, we can measure the relative rotations of the objects in addition to their relative displacements. Instead of just two objects, one could extend this idea to a network of different objects, as depicted in FIG. 2. In case (a) the unit component are similar. In case (b) depicts a hybrid non-inhomogeneous network where each objects of the network could be different that the other.

Range Measurement

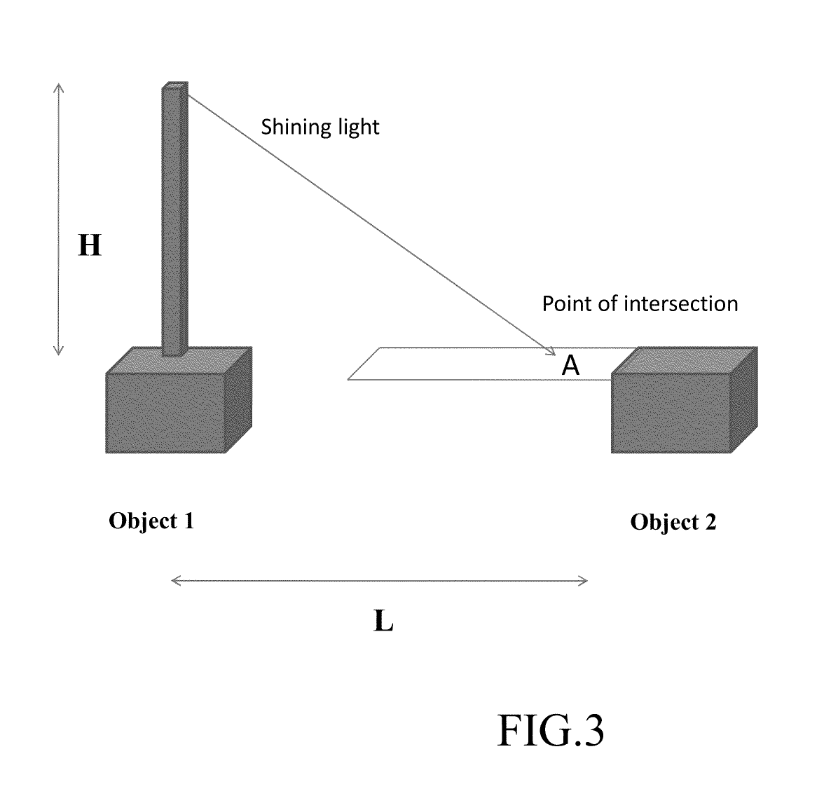

In some specific cases where there are no practical limitations, one could envisage to measure all three-dimensional spatial components of the displacement by adding a measurement with a different angle of incidence. This angle would be between the direction of propagation of the incoming energy beam and the perpendicular to the surface containing the detector cells. One such example is described in FIG. 3. Indeed as there is a relative motion in the range direction, the location of the spot of the beam at the detector will displace relative to the detector.

### Detection Focus on Precision Measurement

The nature of the detector depends on the nature of the energy beam that is used in the experiment. It should be designed such it would deliver at its output a signal (usually an electronic signal) proportional to the intensity of the energy beam that hits its plate. It could be obtained with the help of a unit cell or the combination of unit cells.

We define a unit detecting cell as a sensor that is converting the detecting energy into a signal which can be read by an observer or by an (today mostly electronic) instrument. One could monitor the motion of the energy pattern by monitoring the variation of the detected signal, granted the system is shot noise limited where the sum of all source of errors remain smaller than the shot noise of the measurement. As we perform a differential measurement at different times, any source of error that remains constant is canceled out and thus do not contribute in the error budget of the system.

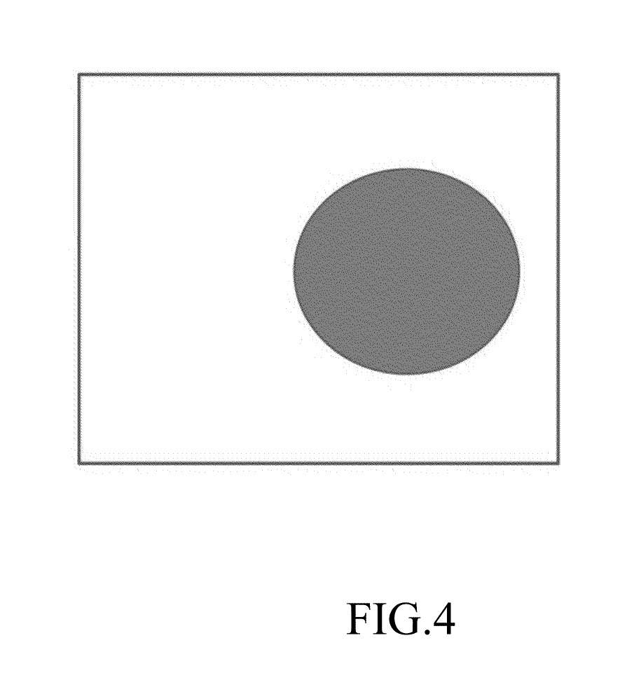

We assume the width and length Ls of the unit cell detector is larger than the energy pattern size W at the detection defined as the length over which the intensity profile of the energy pattern dropped by half, FIG. 1. Let's first assume the simple case where at the detection we are only deploying one unit detecting cell, FIG. 4.

As long as the energy pattern is moving within the detector surface area; there is no mean of detecting its displacement since the variation in the detecting intensity would be within the shot noise. As a side of the energy pattern crosses outside one of the border of the detector, the detected energy intensity decreases and could be translated into useful information when it becomes larger than the shot noise. However no information can be collected as far as the direction of the motion is concerned.

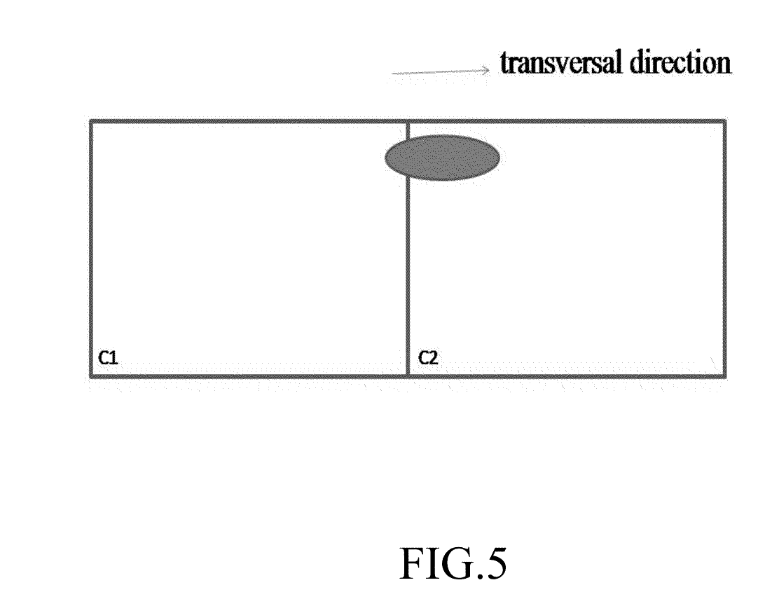

To overcome this problem another unit cell detector could be located next to the previous one. We denote the first detector cell by C1 and the one next to it C2, FIG. 5.

Assuming that the energy pattern has a lateral motion, as it moves out of C1 toward C2 the intensity I1 collected by C1 decreases while the intensity I2 collected by C2 increases; thus it can be shown that the relative displacement of the energy pattern in the transversal direction is proportional to the difference I1-I2.

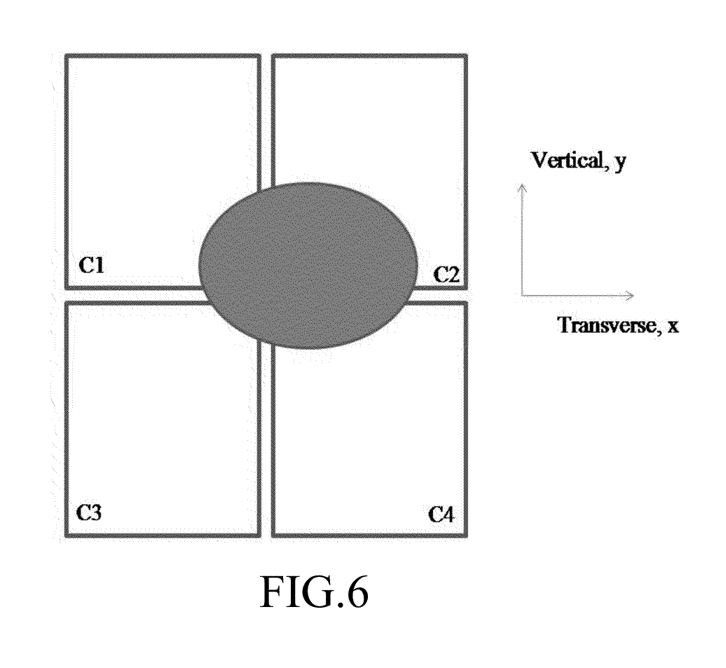

But this setup is not sufficient to determine a vertical direction motion of the energy pattern for similar reason than the unique cell detector cannot determine the direction of the displacement of the pattern. Therefore the determination of both the vertical (x axis) and the horizontal (y axis) displacement directions of the energy pattern require a “quad” cell set up, FIG. 5, decomposed of four unit cell detectors, granted that portion of the energy pattern is always hitting every single detector cell. FIG. 6.

Any displacement in the transversal plane can be decomposed as the sum of a displacement along the x and y axis, thus the quad cell technique allows monitoring any displacement of the energy pattern in the transversal plane.

If the energy pattern experiences a displacement, between tₒ and t₁, then its x-component, Δx, can be measured as:

$$Δ x ≃ W \cdot {( \frac{( {I}_{2} + {I}_{4} ) - ( {I}_{1} + {I}_{3} )}{{I}_{1} + {I}_{2} + {I}_{3} + {I}_{4}} )}_{t = {t}_{1}} - W \cdot {( \frac{( {I}_{2} + {I}_{4} ) - ( {I}_{1} + {I}_{3} )}{{I}_{1} + {I}_{2} + {I}_{3} + {I}_{4}} )}_{t = {t}_{0}} .$$

Likewise, its y-component, Δy, can be measured as, [1,2]:

$$Δ y ≃ W \cdot {( \frac{( {I}_{1} + {I}_{2} ) - ( {I}_{3} + {I}_{4} )}{{I}_{1} + {I}_{2} + {I}_{3} + {I}_{4}} )}_{t = {t}_{1}} - W \cdot {( \frac{( {I}_{1} + {I}_{2} ) - ( {I}_{3} + {I}_{4} )}{{I}_{1} + {I}_{2} + {I}_{3} + {I}_{4}} )}_{t = {t}_{0}} .$$

Where Ii is the intensity of the energy collected by Ci. In the overall the shot noise measurement of the relative displacement of the energy pattern is, [1,2]:

$$\frac{W}{\sqrt{SS}}$$

Coarse Detection Measurement with Greater Field of View

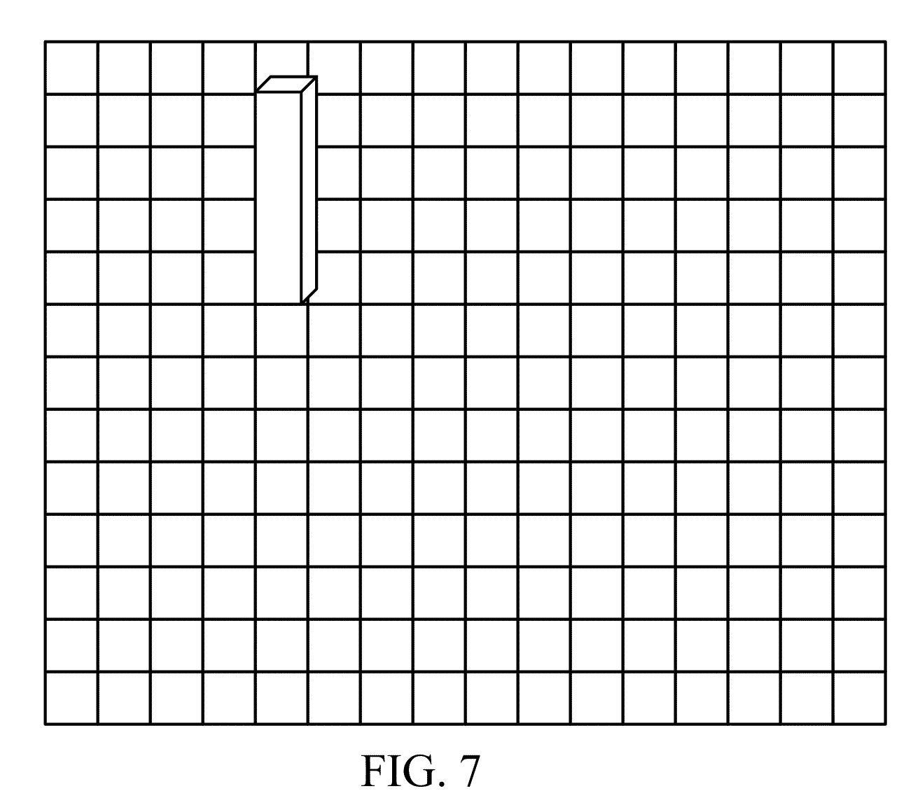

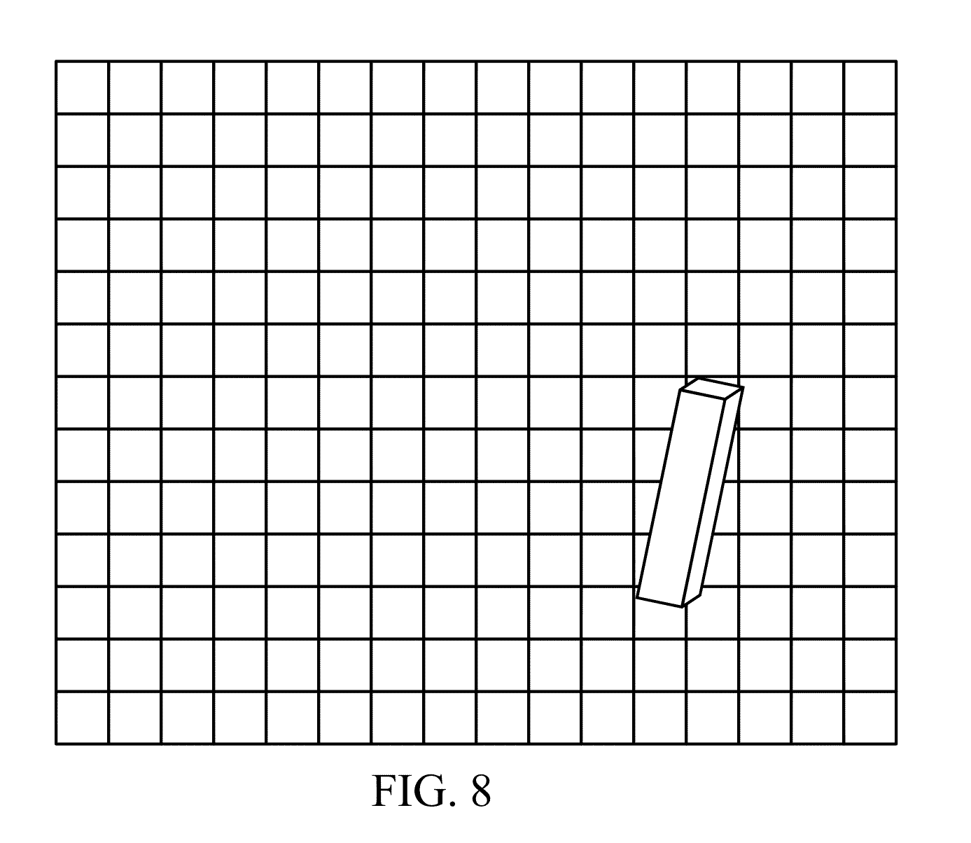

As we will see in the section allocated for the pointing not only we are interested in precise measurement but depending on the application we might be interested in more coarse measurement but where not necessarily the concern is how small can we measure but what is the maximum displacement measurement we could perform. An example among many others pertains to civil engineering applications where we are interest in the motion of building relative to each others as well their rotations. Such motion could be deduce by continuously monitoring the target with the help of a matrix of detector (e.g. a CCD camera). By monitoring continuously the picture of the target, we could deduce the displacement and the rotation of the target, as depicted in FIG. 7 and FIG. 8. FIG. 7 depicts the target initially, while FIG. 8 depicts the location of its image at the detector. Any motion of the position of the target on the screen of the detector could be detected; hence its relative rotation and displacement could be measured and calculated.

### Some Examples of the Physical Nature of the Detectors

As an example in the case of a energy beam consisting a light beam we could either use an optical Position Sensitive Device or a quad cell or even a CCD camera, among many other possibilities, which all of them are available on the market. For instance a Position Sensitive Device and/or Position Sensitive Detector (PSD) is an optical position sensor, that can measure a position of a light spot in one or two-dimensions on a sensor surface. A single unit PSD is composed of a unit semiconductor optical active region. Four electrodes are arranged on all sides of the active region, two anodes and two cathodes. Each anode is facing a cathode. The absorption of a photon in the active region produces holes and electrons in the depletion region of the p-n junction. The reversed bias under which the PSD is typically operating causes the electrons and holes) to move respectively to the anode and cathode electrodes. The current at each electrode is inversely proportional to the distance between that electrode and the centroid of the incoming light since the carrier have to pass through the resistive silicon before reaching their electrodes. Similar structures using at least four different optical sensors (such as Photo Multiplier Tubes or Photodiodes are also existing).

### Analytical Expression and General Notation

In what follows we are trying to express an analytical expression. Let's define a inertial reference relative to which we define the coordinate of each object, which defines the x, y, z axes.

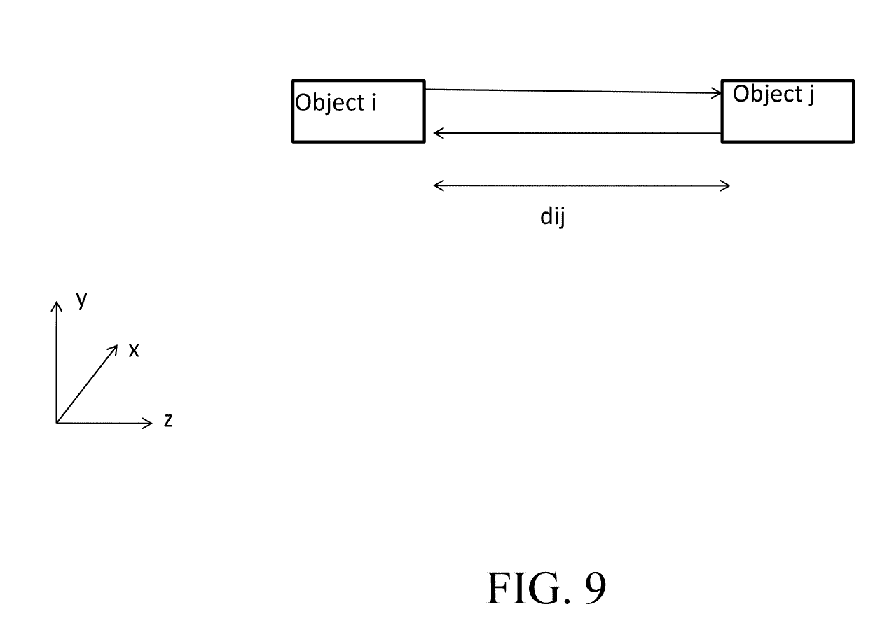

Each object has six degrees of freedom. Let's consider a random object that we designate as i. It has three degrees of freedom in translations, which we denote as:
Tₓ_{ᵢ} the translation of object i along the x axis.
T_{y}_{ᵢ} the translation of object i along the y axis.
T_{z}_{ᵢ} the translation of object i along the z axis.
likewise there is three other degrees of freedom for rotations,
Rₓ_{ᵢ}, rotation of object i along the x axis.
R_{y}_{ᵢ} the rotation of object i along the y axis.
R_{z}_{ᵢ} the rotation of object i along the z axis
Now let's be interested in the relative rotations and translation two objects named here as i and j, as described in FIG. 9, where we denote the z axis the range axis between i and j. Later the same principle of thought could be extended to a large number of objects. The two objects have six degree of freedom as

ΔTₓ=Tₓ_{ᵢ}−Tₓ_{ⱼ} the relative translation along the x axis.

ΔT_{y}=T_{y}_{ᵢ}−T_{y}_{ⱼ} the relative translation along the y axis.

ΔT_{z}=T_{z}_{ᵢ}−T_{z}_{ⱼ} the relative translation along the z axis.

ΔRₓ_{ᵢ}=Rₓ_{ᵢ}−Rₓ_{ⱼ} the relative rotation along the x axis.

ΔR_{y}_{ᵢ}=R_{y}_{ᵢ}−R_{y}_{ⱼ} the relative rotation along the y axis.

ΔR_{z}_{ᵢ}=R_{z}_{ᵢ}−R_{z}_{ⱼ} the relative rotation along the z axis.

In order to analyze we will only look at the displacement along the x axis. The same line of thought could be later being applied to the other axis as well. We are interested in the displacement of the energy beam caused respectively on two random object named here as 1 and 2. This simple case could be later extended to the rest of the network. We call
Let's be first be interested in the different contribution to Δy₂(t)

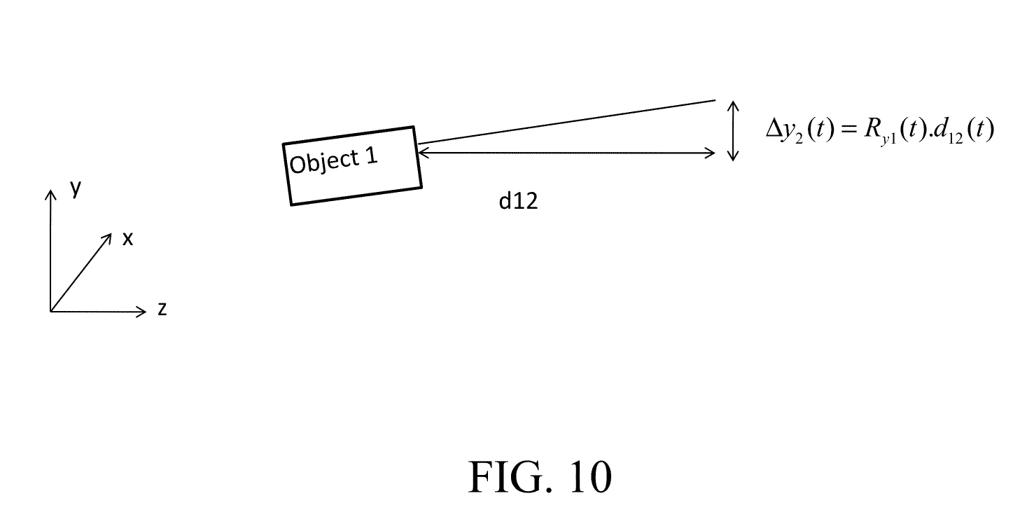

1) The rotation of object 1 as depicted in FIG. 10

Δy₂(t)=R_{y1}(t)·d₁₂(t)

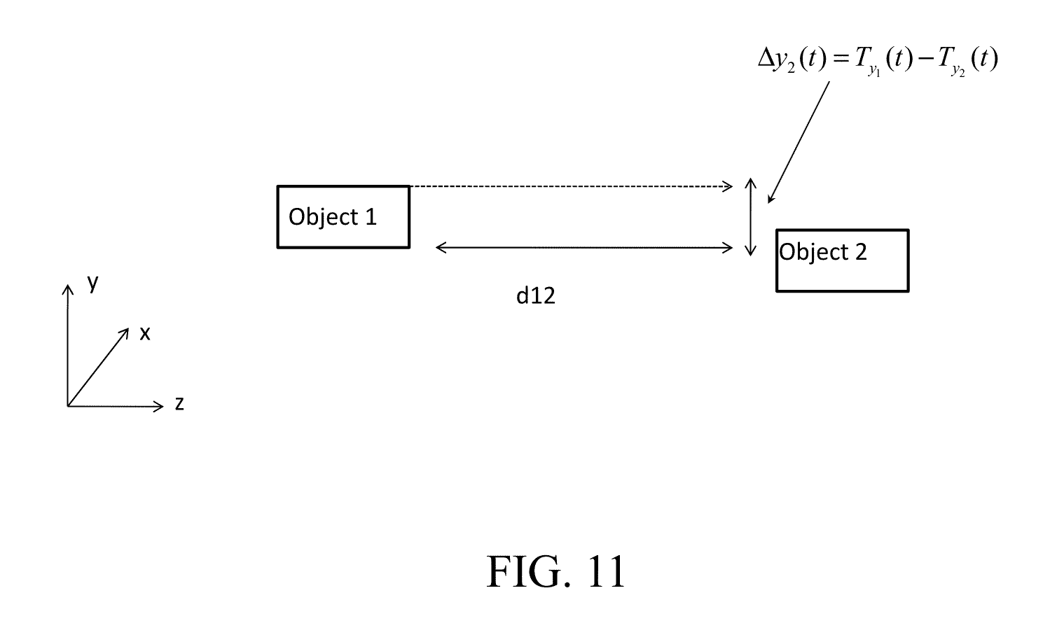

2) The relative translation between 1 and 2 as depicted in FIG. 11

Δy₂(t)=T_{y}_{₁}(t)−T_{y}_{₂}(t)

3) The rotation of the detector (i.e. object 2 here)

As far as a precise measurement is regarded the rotation of the detector induces a displacement of the beam that is smaller than the measurement noise, thus could be neglected.

By adding up the previous remarks we could conclude that:

Δy₂(t)=T_{y}_{₁}(t)−T_{y}_{₂}(t)+R_{y}_{₁}(t)·(d₁₂+Δd₁₂(t))

and by developing the previous expression we obtain:

Δy₂(t)=T_{y}_{₁}(t)−T_{y}_{₂}(t)+R_{y}_{₁}(t)·d₁₂+R_{y}_{₁}(t)·Δd₁₂(t)

whether we proceed by a complementary measurement as discussed earlier that provide information on the change in the range and therefore obtained a three dimensional picture of the displacement including d₁₂(t), or like many application where the |Δd₁₂(t)|<<d₁₂ is a valid approximation. Depending on the application, most often |R_{y}_{₁}(t)·Δd₁₂(t)|<<|R_{y}_{₁}(t)·d₁₂|.
Again depending on the application, often |R_{y}_{₁}(t)·Δd₁₂(t)| is smaller than the measurement error, thus could be neglected.
Following this line of thought, we conclude that:

Δy₂(t)=T_{y}_{₁}(t)−T_{y}_{₂}(t)+R_{y}_{₁}(t)·d₁₂

Similarly we conclude that:

Δy₁(t)=−T_{y}_{₁}(t)+T_{y}_{₂}(t)−R_{y}_{₂}(t)·d₁₂

Combination of the two previous equations leads to the relative measurement of rotation and translation:

$$Δ {R}_{x} ( t ) = {R}_{{x}_{1}} ( t ) - {R}_{{x}_{2}} ( t ) = \frac{Δ {x}_{1} ( t ) + Δ {x}_{2} ( t )}{{d}_{12}}$$

$$and$$

$$Δ {T}_{x} ( t ) = {T}_{{x}_{1}} ( t ) - {T}_{{x}_{2}} ( t ) = \frac{Δ {x}_{1} ( t ) - Δ {x}_{2} ( t )}{{d}_{12}} - ( Δ {x}_{1} ( t ) + Δ {x}_{2} ( t ) )$$

In addition of measuring the relative rotation ΔR_{x,y,z}(t) and translations ΔT_{x,y,z}(t) we could measure individually the translation and rotation of each object separately. That could be obtained by increasing on the network the number of independent measurement such that equals or exceeds the number of total variables. So by that technique not only we could measure the relative rotations and displacements but could measure absolute translation and rotation of each object separately.

Once we have the displacement and rotation of each object, we can deduce the speed and acceleration of each objects as well as their rotation speeds and accelerations.

Pointing Stability

The pointing of the energy beam becomes a concern when either the relative rotation or displacement of the source is such that it induces a displacement of the energy pattern at the detector being larger than half of the detector seize. Thus the detector looses the beam. Such obstacle could be overcome by using a coarse measurement device along the precise measurement technique.

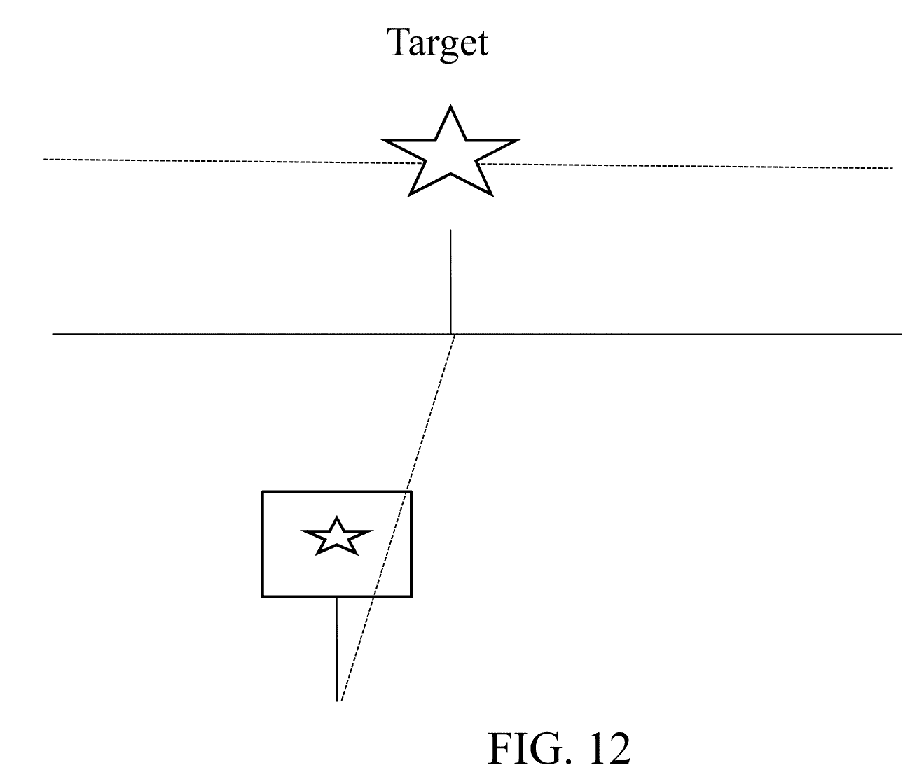

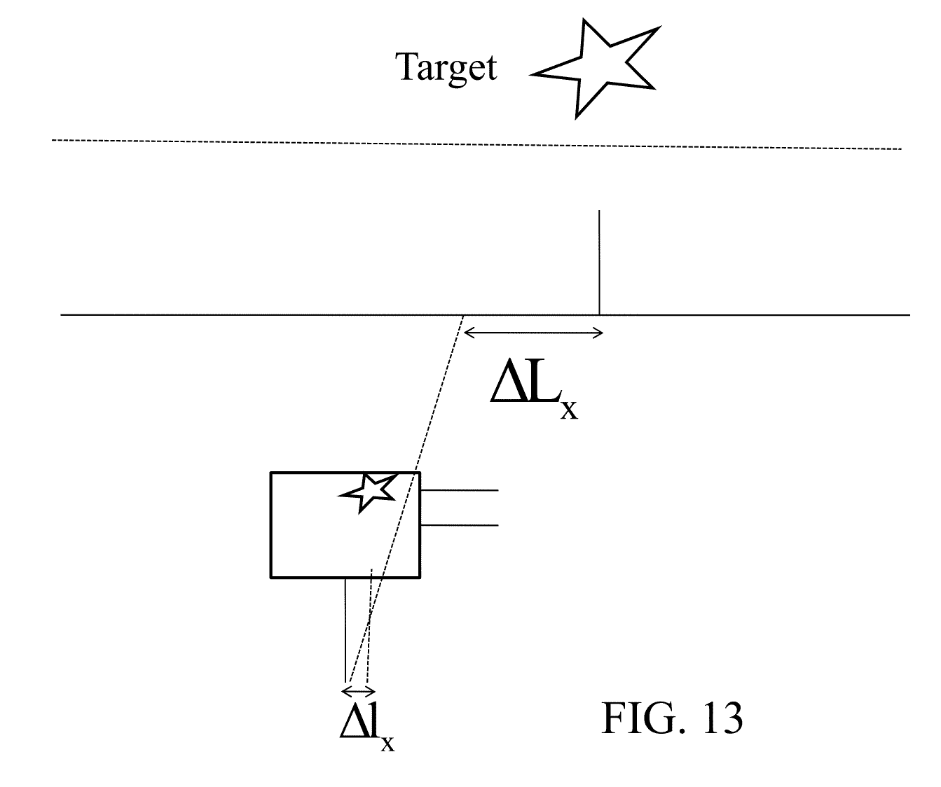

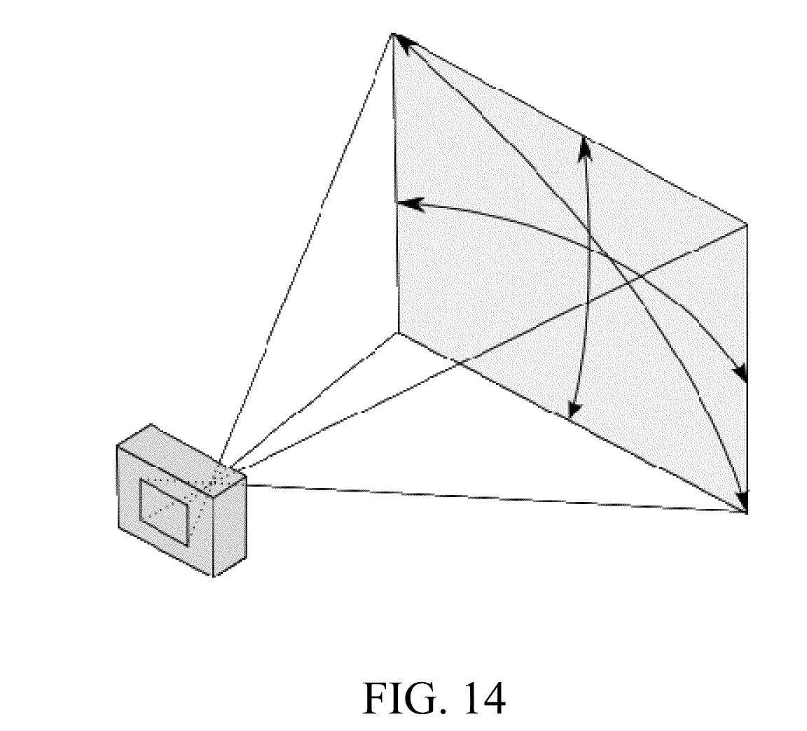

Indeed, for a coarse measurement we suggest using a camera to monitor the motion of the source. The camera per say could be working in any frequency spectrum of interest e.g.: visible, infra red, etc. . . . as depicted in FIG. 7 and FIG. 8.
The camera at the detection selects a specific feature on the target and then on monitors its displacement and rotation on the screen, FIG. 12 and FIG. 13 By knowing what its Field Of View (FOV) is it can monitor the displacement of the feature at a resolution equal to the FOV divided by the number of pixels in that axes, FIG. 14.

The camera could be either a visible, infra-red or a camera working on any other frequency spectrum range. In order for the detector to continuously monitor the target, the detector could continuously take a “movie” of the target; the movie could be broken in a series of images where with the help of an image processing algorithms the displacement of the target is monitored.

### Noise Analysis

It is noteworthy to observe that since we perform a differential measurement, all common mode source of error are canceled. Also by possessing a decent knowledge of the systematic, the effect of the latter in the measurements could be single out during the data processing. We intend to use all available technique of data analysis once we have collected the data.

### Clock Noise

One of the advantages of embodiments of the invention, over the phase measurement technology, consists of not being limited by the Ultra Stable Oscillator (USO) noise in high frequency. The clock is only use as a mean from time tagging.

### Medium-Induced Noise

Since we are performing a differential measurement any source of error that is constant over the measurement integration time cancels out. However changes in the proprieties of the propagation medium could also induced displacement of the detected energy pattern at the detection. For example such changes could include changes in the temperature, density, pressure proprieties of the propagation medium. One mean of overcoming such obstacle consists of extending the number of measurement. For instance in the case of an “active” energy pattern emission of the source, we could use two (or more) energy pattern with different proprieties such the change in the location of the energy pattern at the detection induced by the medium would be different. Hence the difference of the location of the energy patterns could relate to a systematic induced displacement. For example in the case where the energy pattern is a light beam, we could use two light beams with two different wavelengths.

### Skewness of the Data

One may assume that the incoming energy beam has not a symmetrical distribution but rather carry some skew. Since a differential measurement is performed, any exhibited skew in the distribution of the energy pattern does not affect measurements in embodiments of the invention.

### Change in the Proprieties of the Energy Beam

Let's assume that no relative displacement or rotation happened between the source and the target. Let's assume that some intrinsic properties of the energy changes such as for example heat, intensity, temperature, wavelength and others . . . . For the sake of the analysis and as we will look at it later, let's separate the displacement of the energy beam induced by a change in the proprieties in the medium of propagation from the true relative motion and rotation of the target from the detector. A change in the proprieties of the energy beam doesn't displace the beam, but could only change its size and intensity thus changing thus changing the resolution of which the displacement of the beam at the detector is detected.

### Change in Intensity of the Energy Pattern

A change in the intensity energy pattern does not induce any displacement of the pattern at the detection. However, it could change the resolution at which the measurement could be performed at the detection.

### Collimation of the Energy Beam

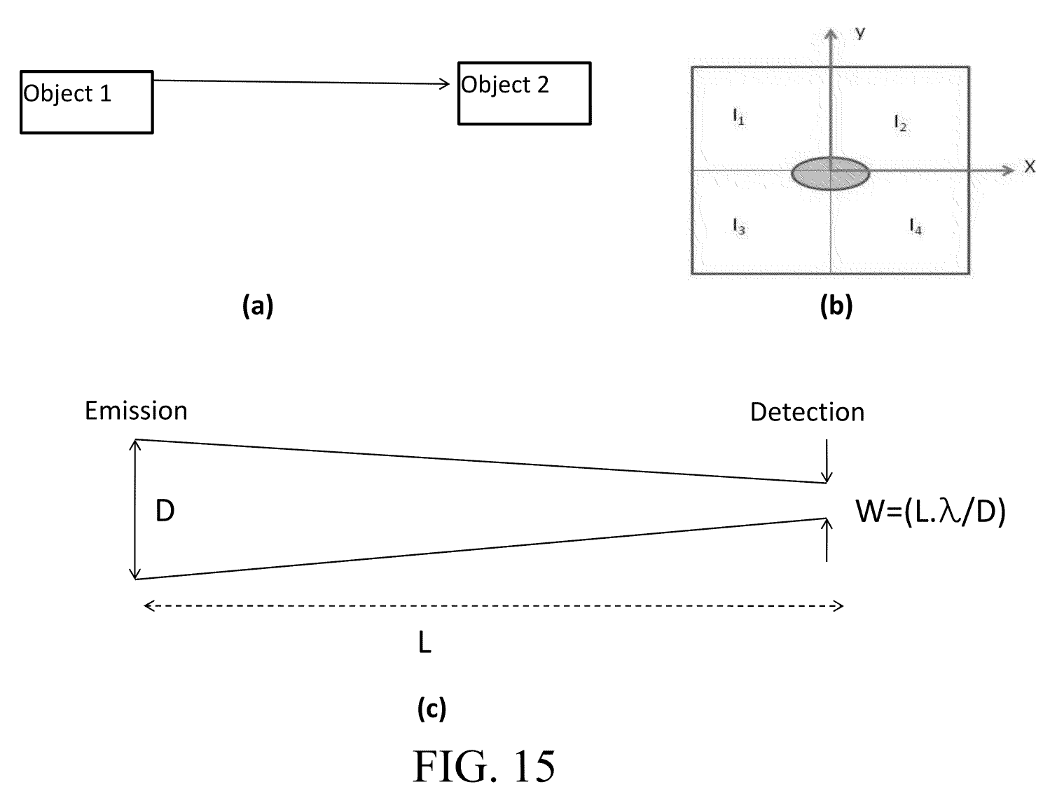

The energy beam emanating from the source could be collimated as illustrated in FIG. 15(c) D being the diameter of the aperture where the beam is coming from and λ the wavelength in the case of an E&M wave. Likewise in the case of a E&M wave the Field Of View of the detector could be increased or decreased by changing the aperture of a lens placed in front of the detector where the lens focuses on the detector any wave coming into it as depicted in FIG. 14.

### Logical Flow

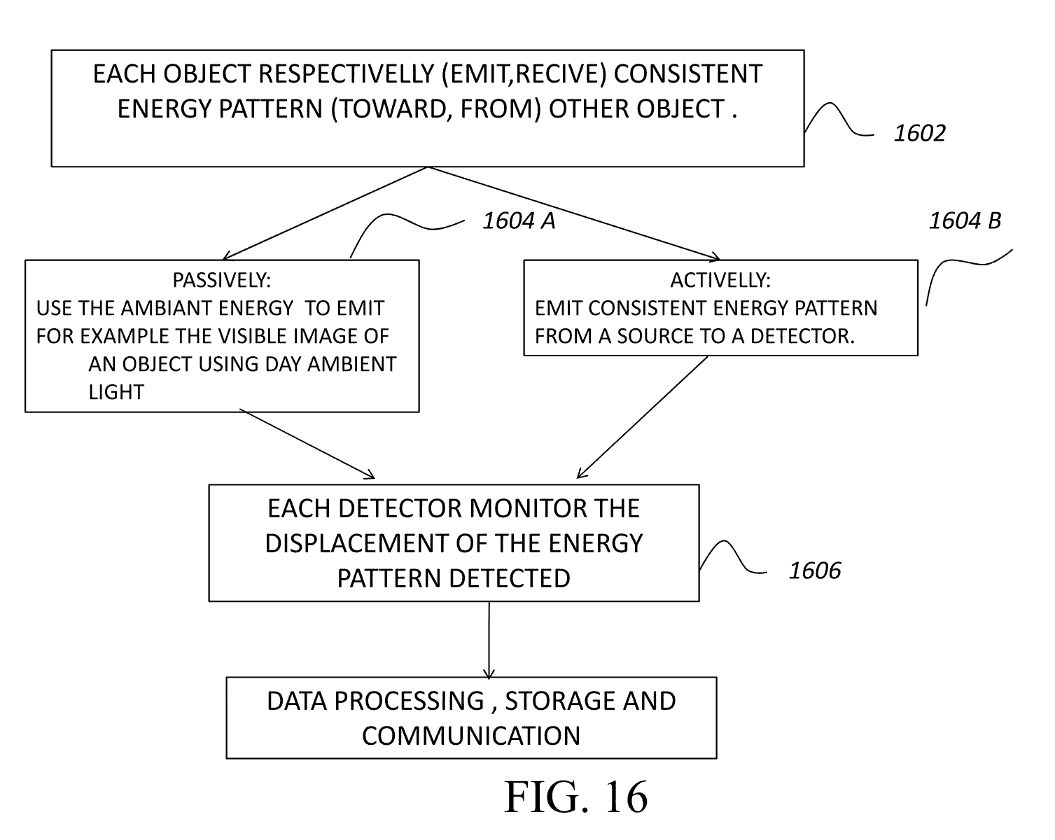

FIG. 16 illustrates the logical flow for measuring a relative displacement and rotation in accordance with one or more embodiments of the invention.

At step 1602, energy patterns are continuously emitted (either passively or actively) from an object acting as a source on other entities acting as the detectors of the source. Each entity could act both as a source and detector of other entities.

Steps 1604 A and 1604B, are a sub step of which differentiate whether the source is acting as an active or passive emitter or both. The case of an active energy consists of the source emitting a beam of energy with a certain pattern toward the detector.

Step 1604A is the case of a passive energy source. In this the source reflects or scatters toward the detector a consistent energy pattern coming from another source or from the ambient. A typical example of such event is the image we perceive of any object during days or ambient light. The image we perceive is the result of the light emitted by sun through earth atmosphere and scattered by the object.

At step 1604B is the case of an active source emitting itself an energy beam toward the detector; each detector detects the energy pattern emitted form a source. Each entity could behave as a source for one or as many as other entities as well as a detector for one or as many as other entities remaining.

At step 1606, the location and displacement of each energy pattern is detected and monitored and feed to the calculation unit of the unit.

At step 1608, all the data processing, storage and communication of data to other entities is proceed. The extracted data could be used to measure the displacement, speed, acceleration, rotation and any others parameters derived from those of each device alone (relative to an inertial frame) or relative to each other. All these data could be use for a plethora of applications relying on the measurement of such parameters.

In embodiments of the invention, relative displacement as small as

$$\frac{W}{\sqrt{SS}}$$

is measured, where W is the width of the energy pattern at the detection, and SS the signal size of the energy pattern at each detection. We are also able to monitor relative displacement between the object as big as the Field Of View of the camera is as depicted in FIG. 14. Each object could be composed of the combination of a precise and a coarse measurement tool. This means that each device has the potential of a measurement Dynamic Range DR (defined as the ratio between the largest and smallest possible values of a changeable quantity) as big as 10 order of magnitude, which is the dynamic range of Earth

### Computer Utilization

The computations/determining/etc. described herein may be conducted using one or more devices within or exterior to the entities (e.g., satellites, planes, etc.) described herein. For example, a computer inside of each entity that is configured with various processors and processing capabilities may be configured to perform the various operations described herein.

FIG. 11 is an exemplary hardware and software environment 1100 used to perform such computations in accordance with one or more embodiments of the invention. The hardware and software environment includes a computer 1102 and may include peripherals. Computer 1102 may be a user/client computer, server computer, or may be a database computer. The computer 1102 comprises a general purpose hardware processor 1104A and/or a special purpose hardware processor 1104B (hereinafter alternatively collectively referred to as processor 1104) and a memory 1106, such as random access memory (RAM). The computer 1102 may be coupled to, and/or integrated with, other devices, including input/output (I/O) devices such as a keyboard 1114, a cursor control device 1116 (e.g., a mouse, a pointing device, pen and tablet, touch screen, multi-touch device, etc.) and a printer 1128. In one or more embodiments, computer 1102 may be coupled to, or may comprise, a portable or media viewing/listening device 1132 (e.g., an MP3 player, iPod™ Nook™, portable digital video player, cellular device, personal digital assistant, etc.). In yet another embodiment, the computer 1102 may comprise a multi-touch device, mobile phone, gaming system, internet enabled television, television set top box, or other internet enabled device executing on various platforms and operating systems.

In one embodiment, the computer 1702 operates by the general purpose processor 1704A performing instructions defined by the computer program 1710 under control of an operating system 1708. The computer program 1710 and/or the operating system 1708 may be stored in the memory 1706 and may interface with the user and/or other devices to accept input and commands and, based on such input and commands and the instructions defined by the computer program 1710 and operating system 1708, to provide output and results.

Output/results may be presented on the display 1722 or provided to another device for presentation or further processing or action. In one embodiment, the display 1722 comprises a liquid crystal display (LCD) having a plurality of separately addressable liquid crystals. Alternatively, the display 1722 may comprise a light emitting diode (LED) display having clusters of red, green and blue diodes driven together to form full-color pixels. Each liquid crystal or pixel of the display 1722 changes to an opaque or translucent state to form a part of the image on the display in response to the data or information generated by the processor 1704 from the application of the instructions of the computer program 1710 and/or operating system 1708 to the input and commands. The image may be provided through a graphical user interface (GUI) module 1718. Although the GUI module 1718 is depicted as a separate module, the instructions performing the GUI functions can be resident or distributed in the operating system 1708, the computer program 1710, or implemented with special purpose memory and processors.

In one or more embodiments, the display 1722 is integrated with/into the computer 1702 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™ etc.), touch tables, and walls (e.g., where an image is projected through acrylic and/or glass, and the image is then backlit with LEDs).

Some or all of the operations performed by the computer 1702 according to the computer program 1710 instructions may be implemented in a special purpose processor 1704B. In this embodiment, the some or all of the computer program 1710 instructions may be implemented via firmware instructions stored in a read only memory (ROM), a programmable read only memory (PROM) or flash memory within the special purpose processor 1704B or in memory 1706. The special purpose processor 1704B may also be hardwired through circuit design to perform some or all of the operations to implement the present invention. Further, the special purpose processor 1704B may be a hybrid processor, which includes dedicated circuitry for performing a subset of functions, and other circuits for performing more general functions such as responding to computer program 1710 instructions. In one embodiment, the special purpose processor 1704B is an application specific integrated circuit (ASIC).

The computer 1702 may also implement a compiler 1712 that allows an application or computer program 1710 written in a programming language such as COBOL, Pascal, C++, FORTRAN, or other language to be translated into processor 1704 readable code. Alternatively, the compiler 1712 may be an interpreter that executes instructions/source code directly, translates source code into an intermediate representation that is executed, or that executes stored precompiled code. Such source code may be written in a variety of programming languages such as Java™ Perl™, Basic™, etc. After completion, the application or computer program 1710 accesses and manipulates data accepted from I/O devices and stored in the memory 1706 of the computer 1702 using the relationships and logic that were generated using the compiler 1712.

The computer 1702 also optionally comprises an external communication device such as a modem, satellite link, WIFI, Ethernet card, any wireless mean of communication or other device for accepting input from, and providing output to, other computers 1702.

In one embodiment, instructions implementing the operating system 1708, the computer program 1710, and the compiler 1712 are tangibly embodied in a non-transient computer-readable medium, e.g., data storage device 1720, which could include one or more fixed or removable data storage devices, such as a zip drive, floppy disc drive 1724, hard drive, CD-ROM drive, tape drive, etc. Further, the operating system 1708 and the computer program 1710 are comprised of computer program 1710 instructions which, when accessed, read and executed by the computer 1702, cause the computer 1702 to perform the steps necessary to implement and/or use the present invention or to load the program of instructions into a memory 1706, thus creating a special purpose data structure causing the computer 1702 to operate as a specially programmed computer executing the method steps described herein. Computer program 1710 and/or operating instructions may also be tangibly embodied in memory 1706 and/or data communications devices 1730, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1702.

### The Network

This is depicted and analyzed in the section dedicated to system claims.

This concludes the description of the preferred embodiment of the invention. Measurements of the displacement and rotations of entities composing an network. Each basic entity of the network could be any object.

This is done by monitoring the relative displacement of the geometrical center of the energy pattern created by an emitting energy source (located on the emitting object) measured at the receiving object through centroid algorithms using . . . .
Any deviation of the geometrical center of the energy pattern relative to the detector can be detected. Such deviation could be used to interpolate or derive a measurement of magnitude of the relative external force experienced by the objects,

Not only this new technology exhibit the ability of measuring the relative rotation and relative displacement between the entities along the three axis of three dimensional reference, but also the absolute rotations and displacements of each entity. This happens when the number of independent measurements exceeds the number of variables. The measurement of displacements leads to straightforward calculation of the speed and acceleration of each entity relative to the others or relative to itself the number of independent measurement exceeds the number of variables.

The measurements of the displacements and rotations of the objects could lead to a large amount of devices using the measurement of displacement, speed, and acceleration and rotation such as seismometer, guiding system, accelerometer, troque meter, rotation meters and many others.

Beside each measurement object could be composed of one unit of precision measurement complemented by a unit of coarse measurement possessing a greater Field Of View, and thus being able to monitor greater displacements thus ruling out any pointing issue as in the case of precise measurement.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. This technique is referred to as Shervin Taghavi Larigani (STL).

### REFERENCES

[1] Sandrine Thomas, Optimized centroid computing in a Shack-Hartmann sensor, Cerro Tololo Inter-American Observatory archive, 2004.

[2] Claire Max. Wavefront Sensing. Lecture 7, Astro 289C, UCSC, Oct. 13, 2011

What is claimed is:

General Claim

1. A method for measuring displacement and rotation, comprising:
A network of objects composed of (one, two or many more) objects. From an object acting as a source emanates an energy beam pattern travelling toward another object, which acts as a detector. At the detector, the position of the center of the pattern of the beam of energy is measured and hence its position relative to the detector is measured using centroid algorithms. Thus the projection of the displacement of the source relative to the detector on the plane of the detector is measured. Following this line of thought the three dimensional relative displacement could be measured if another energy beam pattern emanating from the source at a different angle or the same energy beam but received at another angle at the detecting is monitored. The combination of the two latter measurements yields to deduce the three dimensional motion of the source relative to the detector.

2. The method of claim 1 where the energy beam pattern is composed is energy wave. As an example among others an energy wave pattern could include:
Any electromagnetic waves:
Several examples:
light.
Infra red
Black body radiation
Any other frequency spectrum
Heat waves.
Any mechanical wave
Several examples:
Any acoustic waves.
Ultrasound
Pressure waves.

3. The method of claim 1, where the emanating energy beam pattern is composed of particles. As an example among others an energy particle pattern could be composed of electrons, neutrons, positrons, ions, atoms, molecules or projectiles or any other particles.

4. The method of claim 1, wherein the emitted beam of energy and the corresponding energy pattern is the result of the reflection or scattering of an energy beam on the source. An example of such occurrence pertains to the image of an object with the presence of ambient light. The perceived image of the object is the scattered of ambient light by the object.

5. The method of claim 1, wherein the energy beam pattern is generated at the source.

6. The method of claim 1, wherein:
relative displacement of the energy pattern as small as
$$\frac{W}{\sqrt{SS}}$$
is measured, where W is the width of the smaller feature at the detection and SS is a signal-size being detected and a displacement of the source as large as the Field Of View of the detector panel is measured, as depicted in FIG. 14.

7. The method of claim 1 where each object or station is used as a multipurpose different measurement instruments calculating any output parameters that one could calculate from the fundamental variable measured at each station using our technique. Few example among many others are: accelerometer, torque measurement, seismometer, strain meter, gravitymeter,

[symbol]

8. The method of claim 1, where a multitude of energy beam pattern from a single source travelled to a plural number of detectors. In other words the same source is at the same time the source or target of several different detectors.

9. The method of claim 1, where the detector monitors simultaneously a multitude of energy patterns from different sources or targets.

10. The method of claim 1, where the detector can contain both a precise measure technique allowing to reach its shot noise measurement limit, but as well processing a detecting scheme with large Field of View thus maximizing the maximum range of operation. By combining both technique together the detector could reach a measurement dynamic range (defined as the ratio between the largest and smallest possible measurable values) of 10 orders of magnitude, which is the dynamic range of Earth

11. The method of claim 1, where a single device automatically detects a feature on the target and from then on monitored it automatically

System Claim

12. We claim a network of objects or stations performing the measurement of relative displacement and rotations between the stations or objects using the technique we introduced. The network is composed of unit stations or objects, as depicted in FIG. 15. It could be either composed of one, two or many more objects. One could envisage that the network is composed of homogenous unit stations as depicted in FIG. 2(a) but we also expect to have a hybrid inhomogeneous network. Each station or object of the network could be located either on a moving object such as (satellites, airplanes, balloons, or cars, or others etc. . . . ) or static, like stations on the ground, or composed of both moving and static objects. Each station or object of the network could be located underground, under sea, on ground, on sea in air or in space. Each one of them could be static or mobile and different that the others.

13. Method of claim [12] where an object or station of the network is defined:
i) As an entity that is a target for one or several other detectors on the network or
ii) A detector of one or several other targets (sources) in the network, or
iii) Both the combination of the two previous cases.

14. Method of claim [12] where one station is composed of an object where the user could select the target and the object automatically selects a feature on the target via various images processing feature detection for example similar as to face detection scheme on digital cameras. On mean of doing so would as an example consists of applying an image gradient operator on the filter. We could also add to that unit station of the network an Electronic Distance Measurement (EDM) which measures the range distance to the target, while our imaging scheme measures the transversal position of the target on the screen of the detector. By combing these two techniques in one station, we could monitor the relative displacement of the target relative to the detector as well as its rotations. Indeed if D is the diameter of the lens or the aperture at the detector, the Field Of View is proportional to
$$∼ \frac{L}{D}$$
if the range between the target and the detector as illustrated on in FIG. 15. For example in the case of camera, we could monitor a displacement as big as the FOV and as small as
$$\frac{{FOV}_{x , y}}{{( number of pixel )}_{x , y}}$$
where x and y denotes arbitrarily the two arbitrary axis of the screen of the camera. Indeed once the range distance between the detector and the target is known one could deduce the Field Of View, hence by monitoring any displacement of the position of the target on the screen of the detector deduce the relative three dimensional position of the target relative to the detector and therefore measure and calculated its relative rotation, speed and acceleration relative to the detector. Following this path of though, we could envisage that the detector or the unit station could monitor a multitude of target at the same time.

15. Method of claim [12] where the nature of the energy beam pattern emanating from the sources and detected by the detectors could be of different physical natures within the same network.

16. Method of claim [12] where each station or object could act as the source for one, two or as many other objects in the network.

17. Method of claim [12] where each station or object could act as the detector of one, two or many other objects in the network simultaneously.

18. Method of claim [12] where we design the network such the number of independent measurements is increased such its exceed the number of variables (composed of the rotations and translations of each single unit relative to a inertial frame) not only we would be able to calculate the relative displacements and rotations inside the network but we will be able to calculate absolute rotations and translations of single objects relative to a inertial reference.
